(19) United States
(12) Patent Application Publication
(10) Pub. No.: US 2015/0149613 A1
(43) Pub. Date: May 28, 2015

(54) OPTIMIZED FRAMEWORK FOR NETWORK ANALYTICS

(71) Applicants: Cellco Partnership d/b/a Verizon Wireless, Basking Ridge, NJ (US); Verizon Patent and Licensing Inc., Basking Ridge, NJ (US)

(72) Inventors: Deepak KAKADIA, Antioch, CA (US); Hai Shao, Fremont, CA (US); Yong Gao, Fremont, CA (US); Jin Yang, Orinda, CA (US); Jay J. Lee, San Ramon, CA (US); Donna L. Polehn, Kirkland, WA (US); Thomas H. Tan, San Jose, CA (US)

(73) Assignees: Cellco Partnership d/b/a Verizon Wireless, Basking Ridge, NJ (US); Verizon Patent and Licensing Inc., Basking Ridge, NJ (US)

(21) Appl. No.: 14/090,334

(22) Filed: Nov. 26, 2013

(51) Int. Cl. H04L 12/26

(52) U.S. Cl. CPC H04L 43/04
USPC 709/224

(57) ABSTRACT

A system may receive raw information associated with a network and may prepare the raw information to create optimized information. The optimized information may include the raw information that has been sorted. The system may correlate the optimized information to create a set of correlated information. The system may aggregate at least two sets of correlated information to create aggregated information. The system may determine that network analytics are to be performed using the set of correlated information or the aggregated information. The system may determine information associated with performing the network analytics, including the set of correlated information or the aggregated information. The system may perform the network analytics based on the information associated with performing the network analytics. The system may provide a result associated with performing the network analytics. The result may indicate a manner in which to improve a performance of the network.

### BACKGROUND

Performing network analytics may involve processing raw data to determine useful information (e.g., a trend associated with the performance of the network, an effect of a particular network configuration, a performance of a network device, etc.) that may be used to optimize the performance of the network. The goal of network analytics is to optimize the performance of the network by gaining knowledge that can be used to make improvements and/or changes to the network.

### BRIEF DESCRIPTION OF THE DRAWINGS

FIGS. 1A and 1B are diagrams of an overview of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for optimizing raw information, associated with performing network analytics, and correlating the optimized information;

FIGS. 5A-5C are diagrams of an example implementation relating to the example process shown in FIG. 4;

FIG. 6 is a flow chart of an example process for receiving and aggregating correlated information associated with performing network analytics;

FIG. 7 is a diagram of an example implementation relating to the example process shown in FIG. 6;

FIG. 8 is a flow chart of an example process for performing network analytics and providing a result of the network analytics; and

FIGS. 9A and 9B are diagrams of an example implementation relating to the example process shown in FIG. 8.

### DETAILED DESCRIPTION

The following detailed description of example implementations refers to the accompanying drawings. The same reference numbers in different drawings may identify the same or similar elements.

A service provider, associated with a network, may wish to collect information associated with the operation of the network such that the service provider may optimize the network by reconfiguring the network based on analyzing the collected information. The service provider may collect information from existing analytics sources associated with the network. However, existing analytics sources typically collect and format information for a particular, narrow network issue, which has resulted in a patchwork of closed silo solutions (e.g., case specific solutions) that include information that, when gathered on a large scale, is not optimized for large scale network analytics. As a result, a network analytics device may not be able to discern valuable insights from the collected information (e.g., the information received from the existing analytics sources) that the network analytics device may be able to detect using raw information collected directly from the network (e.g., rather than the existing analytics sources). One solution to this problem is to provide a framework to implement a network analytics solution that may be capable of handling unique challenges associated with information used to perform network analytics (e.g., missing time series data, massaging raw data into a usable form, etc.), such that processing (e.g., associated with performing the network analytics) may be performed in an efficient and/or modular manner. Implementations described herein may allow a network analytics device to collect and process raw analytics information, associated with a network, such that a variety of network analytics may be performed in an optimized manner.

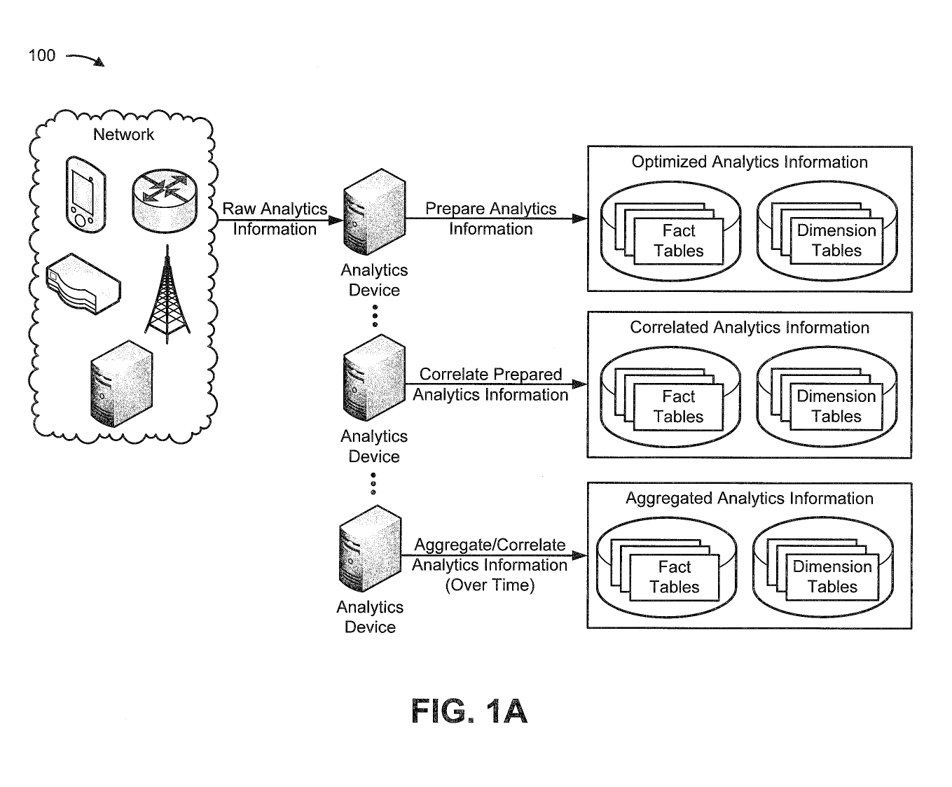

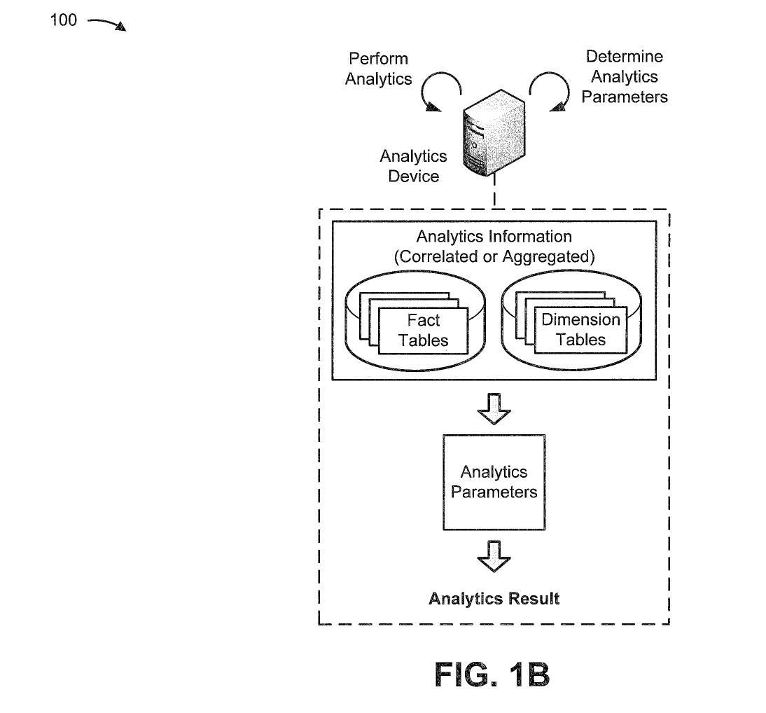

FIGS. 1A and 1B are diagrams of an overview of an example implementation 100 described herein. For the purposes of example implementation 100, assume that a service provider, associated with a network, wishes to perform network analytics that may provide insight associated with optimizing the performance of the network. Further, assume that an analytics device, associated with the network, is positioned to collect raw analytics information (e.g., raw network data) associated with the operation of devices in the network.

As shown in FIG. 1A, assume that various network resources (e.g., routers, gateways, servers, base stations, user devices, etc.), associated with the network, are configured to provide raw analytics information (e.g., performance data, traffic data, configuration data, specification data, etc.) that is to be used when performing network analytics. As shown, the various network resources may provide (e.g., via the network) the raw analytics information to an analytics device associated with the network. As further shown, the analytics device may prepare the raw analytics information, and may store the prepared analytics information (e.g., in dimension tables and fact tables) such that the prepared analytics information is optimized for performing network analytics.

As further shown in FIG. 1A, the analytics device may correlate the prepared analytics information (e.g., such that the correlated analytics information is optimized for performing short term analytics) and may store (e.g., in fact tables and dimension tables) the correlated analytics information. As further shown, the analytics device may aggregate two or more sets of correlated analytics information (e.g., over a period of time), may correlate the aggregated analytics information (e.g., such that the aggregated analytics information is optimized for performing long term analytics), and may store the aggregated analytics information (e.g., in fact tables and dimension tables).

For the purposes of FIG. 1B, assume that the analytics device stores analytics information (e.g., correlated analytics information, aggregated analytics information, etc.) in the form of fact tables and dimension tables. As shown in FIG. 1B, the analytics device may receive information indicating that the analytics device is to perform analytics (e.g., short term analytics, long term analytics, etc.). As further shown, the analytics device may determine parameters, associated with performing the analytics (e.g., parameters that describe a forecast model associated with performing the analytics, etc.). As shown, the analytics device may perform the analytics using the analytics information (e.g., the correlated information or the aggregated information stored in the fact tables and the dimension tables) and the analytics parameters (e.g., by comparing the analytics information to the forecast model described by the parameters, etc.). As further shown, the analytics device may determine a result of performing the analytics (e.g., a result associated with optimizing the performance of the network, a result associated with updating the forecast model, etc.), and the analytics device may provide the result (e.g., to a device associated with optimizing the network). In this way, an analytics device may collect and optimize raw analytics information (e.g., such that network analytics may be performed in an optimized manner), and the analytics device may perform the network analytics based on the optimized analytics information.

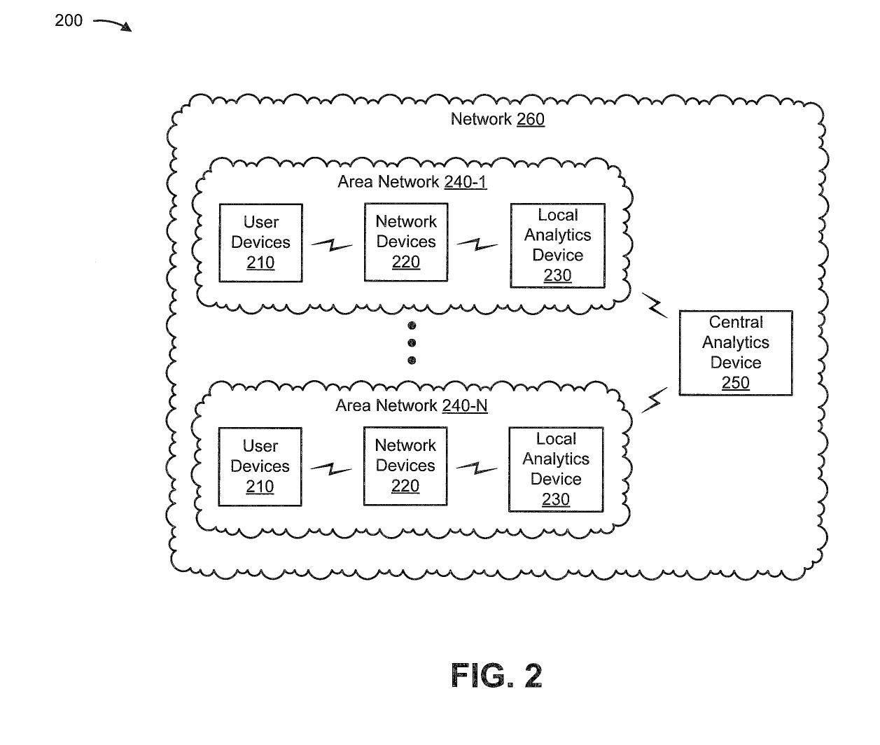

FIG. 2 is a diagram of an example environment 200 in which systems and/or methods described herein may be implemented. As shown in FIG. 2, environment 200 may include user devices 210, network devices 220, local analytics device 230, a set of area networks 240-1 through 240-N (N>1) (hereinafter collectively referred to as “area networks 240,” and individually as “area network 240”), central analytics device 250, and network 260.

User device 210 may include a device capable of communicating with another device (e.g., another user device 210, etc.) via one or more network devices 220, area network 240, and/or network 260. For example, user device 210 may include a radiotelephone, a personal communications system (“PCS”) terminal (e.g., that may combine a cellular radiotelephone with data processing and data communications capabilities), a personal digital assistant (“PDA”) (e.g., that can include a radiotelephone, a pager, Internet/intranet access, etc.), a smart phone, a desktop computer, a laptop computer, a tablet computer, and/or another type of wired or wireless device. In some implementations, a service provider (e.g., associated with area network 240 and/or network 260) may wish to optimize performance of area network 240 and/or network 260 such that a user experience, associated with user device 210, is optimized.

Network device 220 may include one or more devices, included in area network 240 and/or network 260, that may be configured based on the performance of network analytics. For example, network device 220 may include a base station, a gateway, a router, a modem, a switch, a firewall, a network interface card (“NIC”), a hub, a bridge, a server, an optical add/drop multiplexer (“OADM”), a mobility management entity (“MME”), a serving gateway (“SGW”), a packet data network gateway (“PGW”), or another type of device included in area network 240 and/or network 260. In some implementations, network device 230 may be capable of gathering, measuring, receiving, storing, processing, or otherwise obtaining raw analytics information associated with network 240 and/or network 260. In some implementations, network device 230 may provide the raw analytics information to local analytics device 230.

Local analytics device 230 may include a device, included in area network 240, associated with collecting and/or performing network analytics associated with area network 240. For example, local analytics device 230 may include a computing device, such as a server device. In some implementations, local analytics device 230 may include one or more devices capable of receiving, providing, generating, storing, and/or processing information received and/or provided by one or more network devices 220 (e.g., via area network 240). Additionally, or alternatively, local analytics device 230 may be capable of sorting, formatting, preparing, storing, and/or optimizing the storage of analytics information (e.g., such that network analytics may be performed, by local analytics device 230, in an optimized manner). In some implementations, local analytics device 230 may be included in area network 240.

Area network 240 may include one or more wired and/or wireless networks. For example, area network 240 may include a cellular network, a public land mobile network (“PLMN”), a second generation (“2G”) network, a third generation (“3G”) network, a fourth generation (“4G”) network, a fifth generation (“5G”) network, an LTE network, and/or another network. Additionally, or alternatively, area network 240 may include a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks. In some implementations, area network 240 may be associated with a particular geographic area (e.g., a city, a state, etc.) and/or a particular local analytics device 230 (e.g., when local analytics device 230 is configured to perform network analytics for a particular geographic area associated with area network 240). In some implementations, one or more area networks 240 may be included in network 260. In some implementations, area network 240 may allow local analytics device 230 to communicate with central analytics device 250.

Central analytics device 250 may include a device, included in network 260, associated with collecting and/or performing network analytics associated with one or more area networks 240. For example, central analytics device 250 may include a computing device, such as a server device. In some implementations, central analytics device 250 may include one or more devices capable of receiving, providing, generating, storing, and/or processing information received and/or provided by one or more local analytics devices 230 (e.g., via area network 240). Additionally, or alternatively, central analytics device 250 may be associated with a set of local analytics devices 230 (e.g., when central analytics device 250 is configured to perform network analytics based on analytics information received from the set of local analytics devices 230). Additionally, or alternatively, central analytics device 250 may be capable of sorting, formatting, preparing, storing and/or optimizing the storage of analytics information (e.g., such that network analytics may be performed, by central analytics device 250, in an optimized manner). In some implementations, central analytics device 250 may be included in network 260.

Network 260 may include one or more wired and/or wireless networks. For example, network 240 may include a cellular network, a PLMN, a 2G network, a 3G network, a 4G network, a 5G network, an LTE network, and/or another network. Additionally, or alternatively, area network 240 may include a LAN, a WAN, a MAN, a telephone network, an ad hoc network, an intranet, the Internet, a fiber optic-based network, and/or a combination of these or other types of networks. In some implementations, network 260 may be associated with a particular geographic area (e.g., a country, a state, etc.) and may include a set of area networks 240. In some implementations, network 260 may allow local analytics device 230 to communicate with central analytics device 250.

The number of devices and networks shown in FIG. 2 is provided for explanatory purposes. In practice, there may be additional devices and/or networks, fewer devices and/or networks, different devices and/or networks, or differently arranged devices and/or networks than those shown in FIG. 2. Furthermore, two or more of the devices shown in FIG. 2 may be implemented within a single device, or a single device shown in FIG. 2 may be implemented as multiple, distributed devices. Additionally, one or more of the devices of environment 200 may perform one or more functions described as being performed by another one or more of the devices of environment 200. Devices of environment 200 may interconnect via wired connections, wireless connections, or a combination of wired and wireless connections.

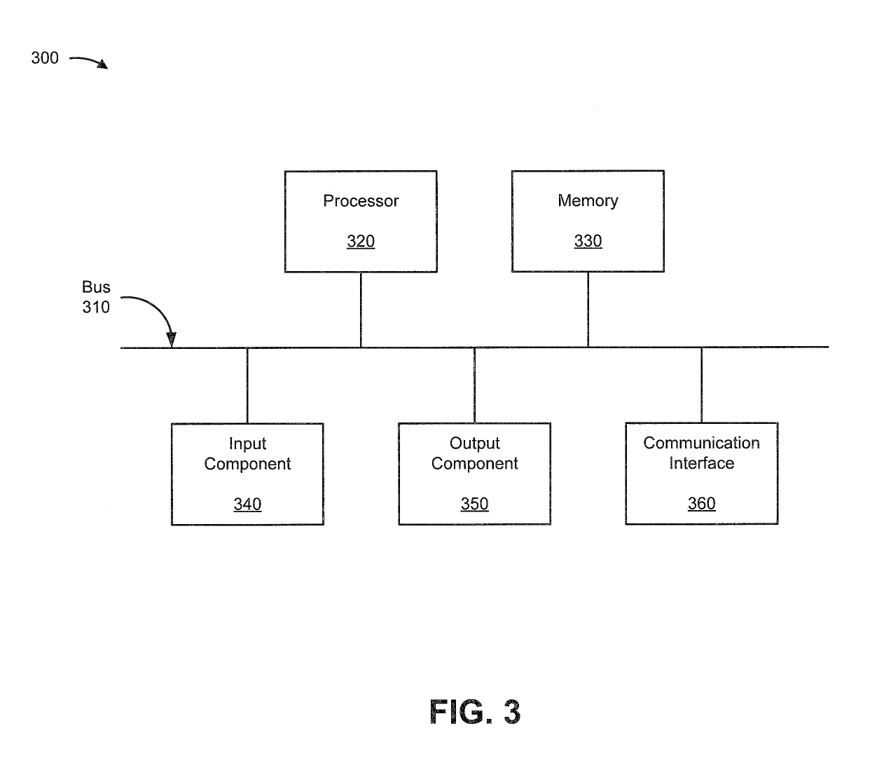

FIG. 3 is a diagram of example components of a device 300. Device 300 may correspond to user device 210, network device 220, local analytics device 230, and/or central analytics device 250. Additionally, or alternatively, each of user device 210, network device 220, local analytics device 230, and/or central analytics device 250 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing component (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash memory, a magnetic memory, an optical memory, etc.) that stores information and/or instructions for use by processor 320.

Input component 340 may include any component that permits a user to input information to device 300 (e.g., a keyboard, a keypad, a mouse, a button, a switch, etc.). Output component 350 may include any component that outputs information from device 300 (e.g., a display, a speaker, one or more light-emitting diodes (“LEDs”), etc.).

Communication interface 360 may include any transceiver-like component, such as a transceiver and/or a separate receiver and transmitter, that enables device 300 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

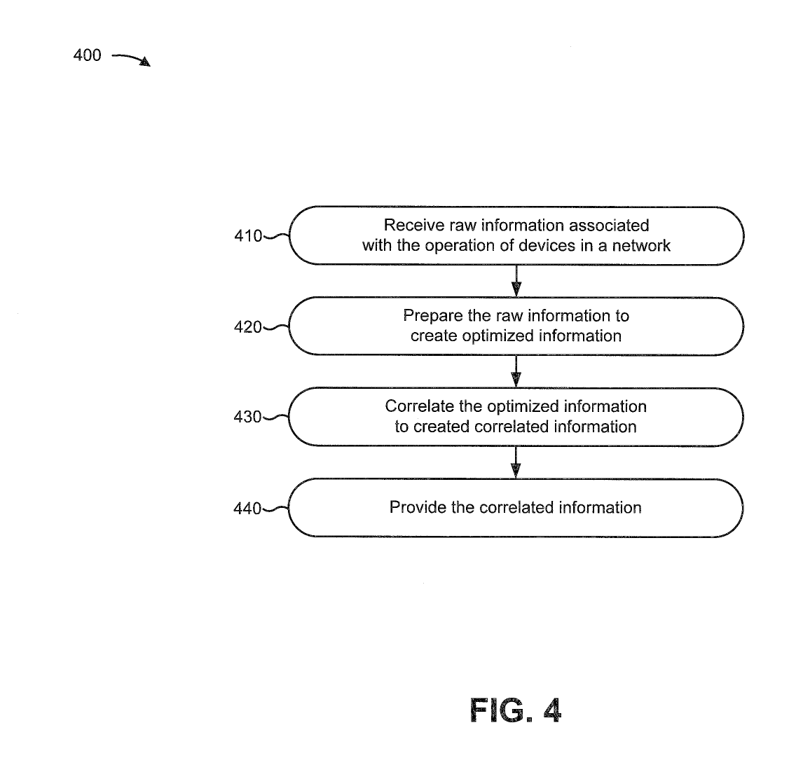

FIG. 4 is a flow chart of an example process 400 for optimizing raw information, associated with performing network analytics, and correlating the optimized information. In some implementations, one or more process blocks of FIG. 4 may be performed by local analytics device 230. In some implementations, one or more process blocks of FIG. 4 may be performed by another device or a group of devices separate from or including local analytics device 230, such as central analytics device 250.

As shown in FIG. 4, process 400 may include receiving raw information associated with the operation of devices in a network (block 410). For example, local analytics device 230 may receive, from network devices 220, raw information associated with the operation of network devices 220 included within area network 240. In some implementations, local analytics device 230 may receive the raw information when one or more network devices 220 provide the raw information. Additionally, or alternatively, local analytics device 230 may receive the raw information from another device (e.g., another device associated with monitoring and/or gathering the raw information).

Raw information may include information, provided by network devices 220, that may be used, by local analytics device 230, to perform network analytics associated with area network 240 and/or network 260 (e.g., after the raw information is prepared and optimized). In some implementations, the raw information may be measured, gathered, collected, determined, stored, or otherwise obtained by network device 220, and network device 220 may provide the raw information to local analytics device 230. In some implementations, the raw information may include dynamic information (e.g., data that varies over a period of time), such as information associated with a key performance indicator (“KPI”) (e.g., a scalar value associated with time series data) associated with network device 220, information associated with monitoring a traffic flow (e.g., packet tracing information, packet routing information, etc.) associated with network devices 220, or the like. Additionally, or alternatively, the raw information may include static information (e.g., information that is not time dependent), such as information associated with a configuration of network device 220 (e.g., a configuration file, etc.), information associated with a forecast model (e.g., information that identifies forecast model parameters, etc.), information associated with determining whether a traffic statistic is within a required range (e.g., a specification file, etc.), or the like.

In some implementations, local analytics device 230 may receive the raw information in real-time (e.g., as the raw information is measured by network device 220). For example, network device 220 may determine data based on a packet trace associated with network device 220 (e.g., when network device 220 is configured to determine the packet trace data every ten seconds, etc.), and network device 220 may provide the packet trace data to local analytics device 230 (e.g., soon after network device 220 determines the packet trace data).

Additionally, or alternatively, local analytics device 230 may receive the raw information on a periodic basis. For example, local analytics device 230 may be configured to receive a configuration file, associated with network device 220 at a particular interval of time (e.g., every one hour, every twenty-four hours, etc.). Additionally, or alternatively, local analytics device 230 may receive the raw information when the raw information is updated (e.g., when network device 220 receives an updated specification file, network device 220 may provide the updated specification file to local analytics device 230, etc.).

As further shown in FIG. 4, process 400 may include preparing the raw information to create optimized information (block 420). For example, local analytics device 230 may prepare the raw information to create optimized information. In some implementations, local analytics device 230 may prepare the raw information when local analytics device 230 receives the raw information. Additionally, or alternatively, local analytics device 230 may prepare the raw information at a particular interval of time (e.g., at one minute batch time intervals, at ten minute batch time intervals, etc.). Additionally, or alternatively, local analytics device 230 may prepare the raw information when local analytics device 230 receives information, indicating that local analytics device 230 is to prepare the raw information, from another device (e.g., network device 220, central analytics device 250, etc.).

In some implementations, preparing the raw information may include sorting the raw information. For example, local analytics device 230 may receive various types of raw information (e.g., network KPI data, traffic data, configuration data, specification data, etc.), and local analytics device 230 may sort the raw information based on the type of the raw information (e.g., such that each different type of raw information may be distinguished from each other type of raw information). Additionally, or alternatively, the raw information may be sorted based on a proposed use associated with the raw information (e.g., when the raw information is to be used for analytics associated with a quality of service (“QoS”) queue backlog, the raw information may be sorted based on the proposed use of the raw information for the QoS queue backlog analytics, etc.).

Additionally, or alternatively, preparing the raw information may include formatting the raw information. For example, the raw information may be received in a first format (e.g., an extensible markup language (“XML”) format, a binary format, etc.), and local analytics device 230 may prepare the raw information by converting the first format to a second format (e.g., a second format that may be compatible with analytics software associated with local analytics device 230).

Additionally, or alternatively, preparing the raw information may include modifying the raw information. For example, local analytics device 230 may receive raw information, determined by a first network device 220, associated with a network KPI, and may receive raw information, determined by a second network device 220, associated with the network KPI. In this example, local analytics device 230 may modify the raw information (e.g., associated with the first network device 220 and/or the second network device 220) by adding information to the raw information (e.g., local analytics device 230 may extrapolate, or otherwise estimate, missing information and add the extrapolated information to fill in gaps in the network KPI information associated with the first network device 220 and/or the second network device 220) such that local analytics device 230 may be capable of correlating the modified raw information (e.g., associated with the first network device 220 and the second network device 220) before performing network analytics. In some implementations, adding information that is missing from the raw information may be important when local analytics device 230 performs an operation (e.g., a JOIN operation, etc.) associated with correlating the prepared raw information. For example, a correlation may fail when a JOIN operation is performed using raw information that is missing information (e.g., this is a chronic problem when performing network analytics that depend on time series raw data since times, associated with the time series data, must correlate).

In some implementations, preparing the raw information may include creating dimension tables and fact tables that may be used to store the prepared information. For example, local analytics device 230 may create a group of dimension tables that include the raw information (e.g., a first dimension table may include a first type of raw information, a second dimension table may include a second type of raw information, etc.), and local analytics device 230 may create a fact table based on the raw information included in the dimension tables (e.g., such that the fact table includes information associated with a relationship between the raw information included in the first dimension table and the raw information included in the second dimension table). In some implementations, local analytics device 230 may create the dimension tables and fact tables such that the raw information may be determined (e.g., queried) in an optimized manner (e.g., when the fact tables and the dimension tables are created such that a particular operation, such as a JOIN operation associated with correlating the raw information, may be efficiently executed, etc.).

In some implementations, the creation of the dimension tables and fact tables may allow for efficient processing of the information (e.g. optimized information, correlated information, aggregated information, etc.) stored in the dimension tables and fact tables. For example, a fact table may be large (e.g., as compared to a dimension table), and may be based on information derived from the dimension table. The dimension table may be small (e.g., as compared to the fact table), and may include a single primary key. The separation of the information into the fact tables and dimension tables may result in more efficient processing (e.g., when the dimension tables are joined and/or correlated with the fact tables). Moreover, the separation of the information into the fact tables and the dimension tables may allow an operation (e.g., a JOIN operation, a GROUP BY operation, etc.) to execute in an efficient manner.

Optimized information may include raw information that has been prepared by local analytics device 230 (e.g., in one or more manners, including, but not limited to, those described above). In some implementations, the optimized information may be created and/or stored (e.g., fact tables and dimension tables, etc.) such that local analytics device 230 may correlate the optimized information in an optimized manner (e.g., as compared to correlating the unprepared raw information). Additionally, or alternatively, the optimized information may allow for an optimized performance of an operation (e.g., a JOIN operation, an INNER JOIN operation, etc.) associated with correlating the optimized information.

In some implementations, local analytics device 230 may store (e.g., in a memory location of local analytics device 230, such as a RAM, a hard disk, etc.) the optimized information (e.g., after local analytics device 230 prepares the raw information to create the optimized information). In some implementations, the optimized information may be added to existing optimized information (e.g., when local analytics device 230 adds the optimized information to an existing dimension table and/or fact table, stored by local analytics device 230, that includes optimized information). Additionally, or alternatively, the optimized information may replace existing optimized information (e.g., when local analytics device 230 overwrites existing optimized information with new optimized information).

As further shown in FIG. 4, process 400 may include correlating the optimized information to created correlated information (block 430). For example, local analytics device 230 may correlate the optimized information to create correlated information. In some implementations, local analytics device 230 may correlate the optimized information when local analytics device 230 creates the optimized information (e.g., after local analytics device 230 prepares the raw information to create the optimized information). Additionally, or alternatively, local analytics device 230 may correlate the optimized information when local analytics device 230 receives information indicating that local analytics device 230 is to perform network analytics (e.g., based on the optimized information). Additionally, or alternatively, local analytics device 230 may correlate the optimized information when local analytics device 230 receives information, indicating that local analytics device 230 is to correlate the optimized information, from another device (e.g., another device included in area network 240, central analytics device 250, etc.).

Correlating the optimized information may include identifying a relationship associated with two or more portions of the optimized information and storing information associated with the relationship. For example, local analytics device 230 may identify a relationship between a first portion of the optimized information (e.g., information that identifies a packet trace measurement) and a second portion of the optimized information (e.g., information that identifies a router configuration associated with the packet trace measurement), and local analytics device 230 may store (e.g., in a fact table and/or a dimension table) information associated with the correlated information. In some implementations, the correlated information may stored (e.g., in fact tables and dimension tables, etc.) such that local analytics device 230 may perform network analytics (e.g., short term network analytics) in an optimized manner (e.g., as compared to performing network analytics on uncorrelated information). Additionally, or alternatively, the correlated information may allow for an optimized performance of an operation (e.g., a JOIN operation, an INNER JOIN operation, etc.) associated with performing the network analytics.

In some implementations, the correlated information may be used (e.g., by local analytics device 230) to perform short term network analytics. For example, local analytics device 230 may correlate optimized information (e.g., associated with a particular area network 240), and local analytics device 230 may perform short term network analytics (e.g., associated with area network 240) based on the correlated information, as discussed below. Short term analytics may include analytics performed on highly granular optimized information (e.g., optimized information with a short batch time, such as one minute) to produce near real-time analytics insights. In some implementations, short term analytics may be performed by one or more local analytics devices 230 that may be distributed throughout network 260 (e.g., when each area network 240 included in network 260 includes a local analytics device 230), such that each local analytics device 230 may perform short term analytics associated with a particular area network 240.

In some implementations, local analytics device 230 may store (e.g., in a memory location of local analytics device 230, such as a RAM, a hard disk, etc.) the correlated information in the form of one or more fact tables and/or one or more dimension tables (e.g., after local analytics device 230 correlates the optimized information). In some implementations, the correlated information may be added to existing correlated information (e.g., when local analytics device 230 adds the correlated information to an existing dimension table and/or fact table, stored by local analytics device 230, that includes correlated information). Additionally, or alternatively, the correlated information may replace existing correlated information (e.g., when local analytics device 230 overwrites existing correlated information with new correlated information).

As further shown in FIG. 4, process 400 may include providing the correlated information (block 440). For example, local analytics device 230 may provide, to central analytics device 250, the correlated information. In some implementations, local analytics device 230 may provide the correlated information when local analytics device 230 correlates the optimized information (e.g., after local analytics device 230 correlates the optimized information). Additionally, or alternatively, local analytics device 230 may provide the correlated information when local analytics device 230 receives information, indicating that local analytics device 230 is to provide the correlated information, from another device (e.g., central analytics device 250, etc.).

In some implementations, local analytics device 230 may provide the correlated information to another device (e.g., central analytics device 250) for further processing (e.g., when central analytics device 250 is configured to aggregate correlated information received from one or more local analytics devices 230). Additionally, or alternatively, local analytics device 230 may provide the information to another device for storage.

Although FIG. 4 shows example blocks of process 400, in some implementations, process 400 may include additional blocks, different blocks, fewer blocks, or differently arranged blocks than those depicted in FIG. 4. Additionally, or alternatively, one or more of the blocks of process 400 may be performed in parallel.

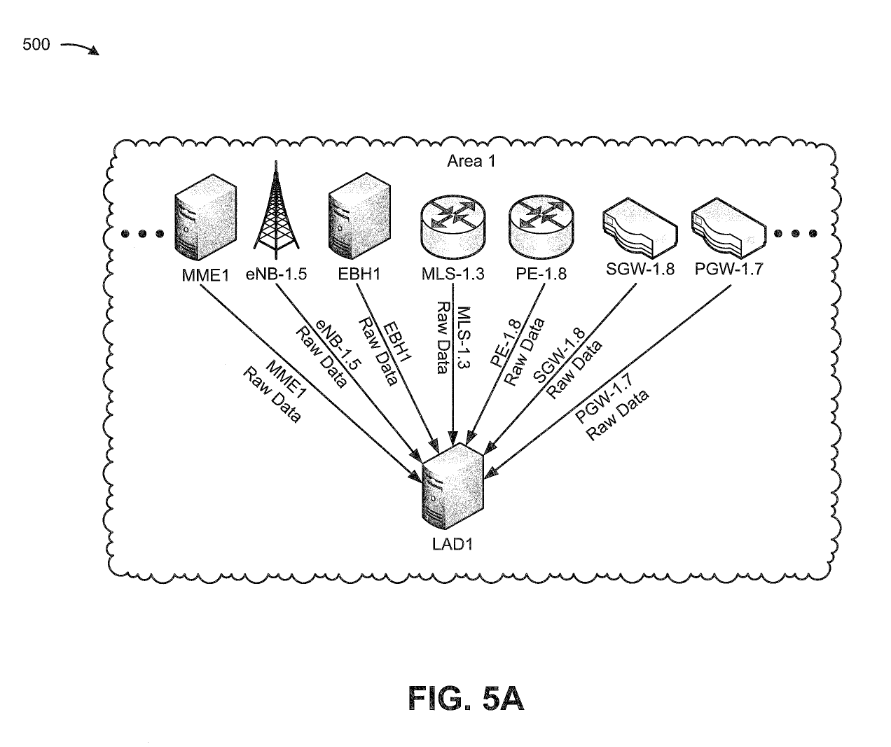

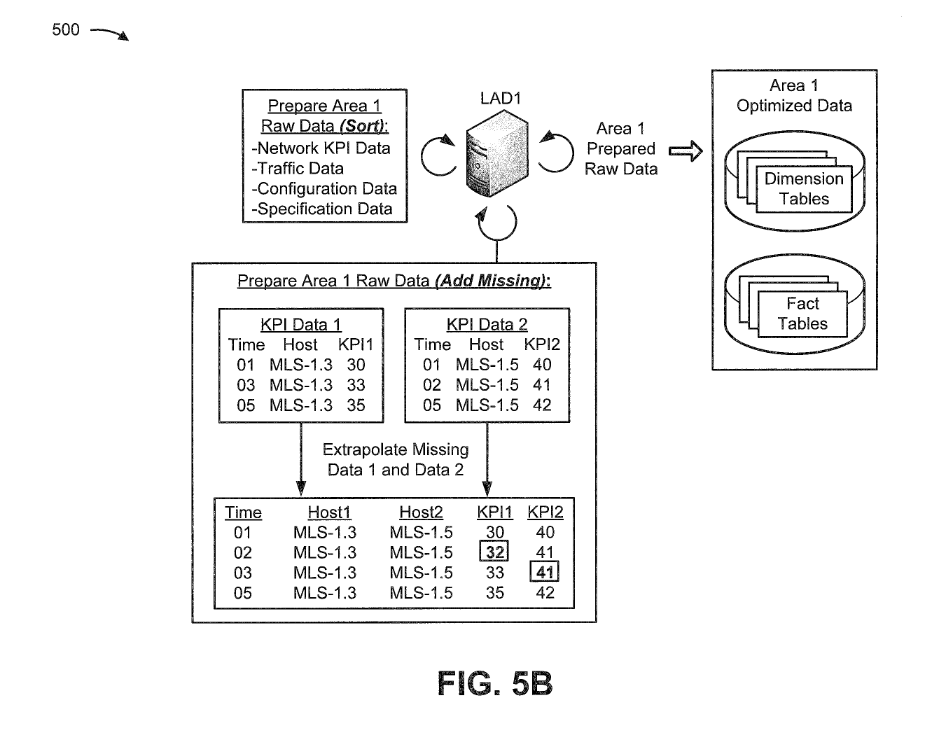

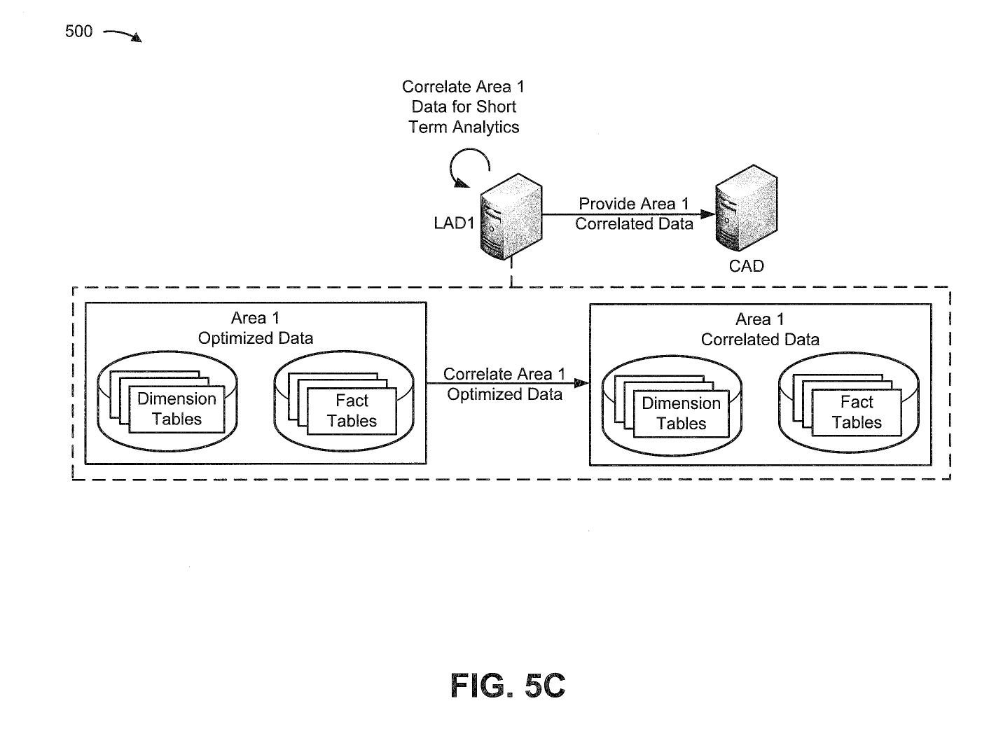

FIGS. 5A-5C are diagrams of an example implementation 500 relating to example process 400 shown in FIG. 4. For the purposes of example implementation 500, assume that a network, area 1, includes a number of network devices, including an MME (e.g., MME1), an eNodeB (e.g., eNB-1.5), an Ethernet backhaul device (e.g., EBH1), a multilayer switch (e.g., MLS-1.3), an edge router (e.g., PE-1.8), an SGW (e.g., SGW-1.8), and a PGW (e.g., PGW-1.7). Further, assume that a local analytics device, LAD1, is positioned to receive raw data from each network device included in the area 1 network.

As shown in FIG. 5A, MME1, eNB-1.5, EBH1, MLS-1.3, PE-1.8, SGW-1.8, and PGW-1.7 (e.g., and other area 1 network devices) may provide raw analytics data, such as network KPI data associated with each device, traffic data associated with the area 1 network (e.g., packet tracing data, packet routing data, etc.), configuration data associated with each device (e.g., router configuration data, switch configuration data, etc.), specification data associated with area 1 traffic (e.g., QoS requirements for a particular area 1 traffic flow, etc.), and LAD1 may receive the raw analytics data.

As shown in FIG. 5B, LAD1 may prepare the raw analytics data (e.g., to create optimized data) by first sorting the data. As shown, LAD1 may be configured to sort the raw analytics data based on whether each portion of the raw analytics data (e.g., received from the various area 1 devices) includes network KPI data, traffic data, configuration data, or specification data.

As further shown, LAD1 may also prepare the raw analytics data by adding extrapolated data to the raw analytics data (e.g., such that data may be optimized for correlation). For example, as shown, LAD1 may receive a first piece of raw analytics data, KPI data 1, associated with a first network device, MLS-1.3, that includes KPI information associated with three different timestamps (e.g., when MLS-1.3 determined that the KPI value was 30 at time 01, that the KPI value was 33 at time 03, and that the KPI value was 35 at time 05). Similarly, LAD1 may receive a second piece of raw analytics data, KPI data 2, associated with a second network device, MLS-1.5, that includes KPI information (e.g., the same KPI as included in data 1) associated with three different timestamps (e.g., when MLS-1.5 determined that the KPI value was 40 at time 01, that the KPI value was 41 at time 02, and that the KPI value was 42 at time 05). As shown, LAD1 may fill in missing data (e.g., since data 1 did not include a KPI value at time 02, and data 2 did not include a KPI value at time 03) by extrapolating the missing data (e.g., LAD1 may determine an extrapolated value of 32 for data at time 02, LAD1 may determine an extrapolated value of 41 for data 2 at time 03) such that data 1 and data 2 may be optimized for correlation.

As further shown in FIG. 5B, LAD1 may store the optimized area 1 data in dimension tables and fact tables. For example, LAD1 may store a dimension table that includes optimized data associated with packet trace data of the area 1 network and a dimension table that includes optimized data associated with configuration data that identifies one or more area 1 network devices. In this example, LAD1 may generate a fact table that identifies a network device (e.g., as identified in the optimized configuration data) associated with each packet trace (e.g., identified in the optimized raw packet trace data). In this way, LAD1 may receive and prepare raw analytics data (e.g., KPI information, traffic data, configuration files, specification files, etc.) such that the raw analytics data is stored in an manner that allows for optimized correlation (e.g., when the optimized data is read for correlation to perform network analytics, when an operation, such as a JOIN, is applied to the optimized data, etc.).

As shown in FIG. 5C, LAD1 may determine (e.g., based on information, received by LAD1, associated with performing short term analytics) that LAD1 is to correlate the optimized analytics data, stored by LAD1, for the performance of short term analytics. As shown, LAD1 may correlate the optimized analytics information (e.g., by identifying a relationship between two or more portions of the optimized information), and may store the correlated area 1 data in a group of fact and dimension tables (e.g., such that the correlated area 1 data is optimized to be read by LAD1 for the performance of short term analytics). As further shown, LAD1 may also provide the correlated area 1 data to a central analytics device, CAD, (e.g., a device associated with performing long term analytics).

As indicated above, FIGS. 5A-5C are provided merely as an example. Other examples are possible and may differ from what was described with regard to FIGS. 5A-5C.

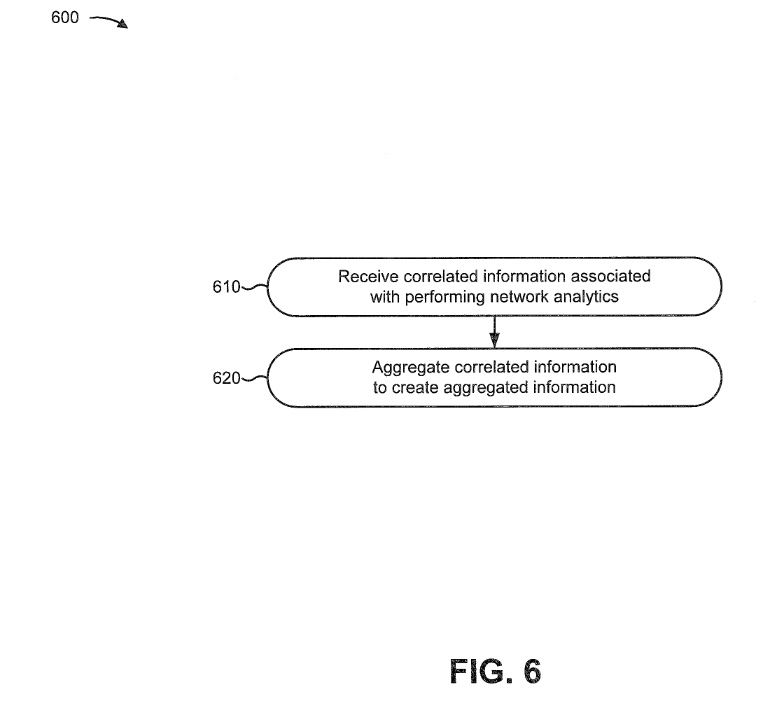

FIG. 6 is a flow chart of an example process 600 for receiving and aggregating correlated information associated with performing network analytics. In some implementations, one or more process blocks of FIG. 6 may be performed by central analytics device 250. In some implementations, one or more process blocks of FIG. 6 may be performed by another device or a group of devices separate from or including central analytics device 250, such another device included in network 260.

As shown in FIG. 6, process 600 may include receiving correlated information associated with performing network analytics (block 610). For example, central analytics device 250 may receive, from local analytics device 230, correlated information associated with performing network analytics associated with network 260. In some implementations, central analytics device 250 may receive the correlated information when one or more local analytics devices 230 provide the correlated information (e.g., when central analytics device 250 is configured to aggregate correlated information from the one or more local analytics devices 230). Additionally, or alternatively, central analytics device 250 may receive the correlated information from another device (e.g., another device included in area network 240).

As further shown in FIG. 6, process 600 may include aggregating the correlated information to create aggregated information (block 620). For example, central analytics device 250 may aggregate the correlated information (e.g., received from local analytics devices 230) to create aggregated information. In some implementations, central analytics device 250 may aggregate the correlated information when central analytics device 250 receives the correlated information from local analytics devices 230 (e.g., after local analytics devices 230 provide the correlated information). Additionally, or alternatively, central analytics device 250 may aggregate the correlated information when central analytics device 250 receives information, indicating that central analytics device 250 is to aggregate the correlated information from another device (e.g., another device included in network 260).

Aggregating correlated information may include receiving correlated information (e.g., received from a group of local analytics devices 230), identifying a relationship associated with two or more portions of the correlated information, and storing information associated with the relationship. For example, central analytics device 250 may receive correlated information (e.g., from a first local analytics device 230 and a second local analytics device 230), may identify a relationship between a first portion of the correlated information, received from the first local analytics device 230, and a second portion of the correlated information received from the second local analytics device 230, and central analytics device 250 may store (e.g., in a fact table and/or a dimension table) information associated with the relationship.

In some implementations, the aggregated information may be stored such that long term network analytics may be performed in an optimized manner. For example, central analytics device 250 may aggregate correlated information (e.g., associated with two or more area networks 240 included in network 260), and central analytics device 250 may perform long term analytics (e.g., associated with network 260) based on the aggregated information, as discussed below. Long term analytics may include analytics performed on low granular correlated information (e.g., correlated information with a long batch time, such as one month) to produce long range analytics insights.

In some implementations, central analytics device 250 may store (e.g., in a memory location of central analytics device 250, such as a RAM, a hard disk, etc.) the aggregated information in fact tables and dimension tables (e.g., after central analytics device 250 aggregates the correlated information). In some implementations, the aggregated information may be added to existing aggregated information (e.g., when central analytics device 250 adds the aggregated information to an existing dimension table and/or fact table, stored by central analytics device 250, that includes aggregated information). Additionally, or alternatively, the aggregated information may replace existing aggregated information (e.g., when central analytics device 250 overwrites existing aggregated information with new aggregated information).

Although FIG. 6 shows example blocks of process 600, in some implementations, process 600 may include additional blocks, different blocks, fewer blocks, or differently arranged blocks than those depicted in FIG. 6. Additionally, or alternatively, one or more of the blocks of process 600 may be performed in parallel.

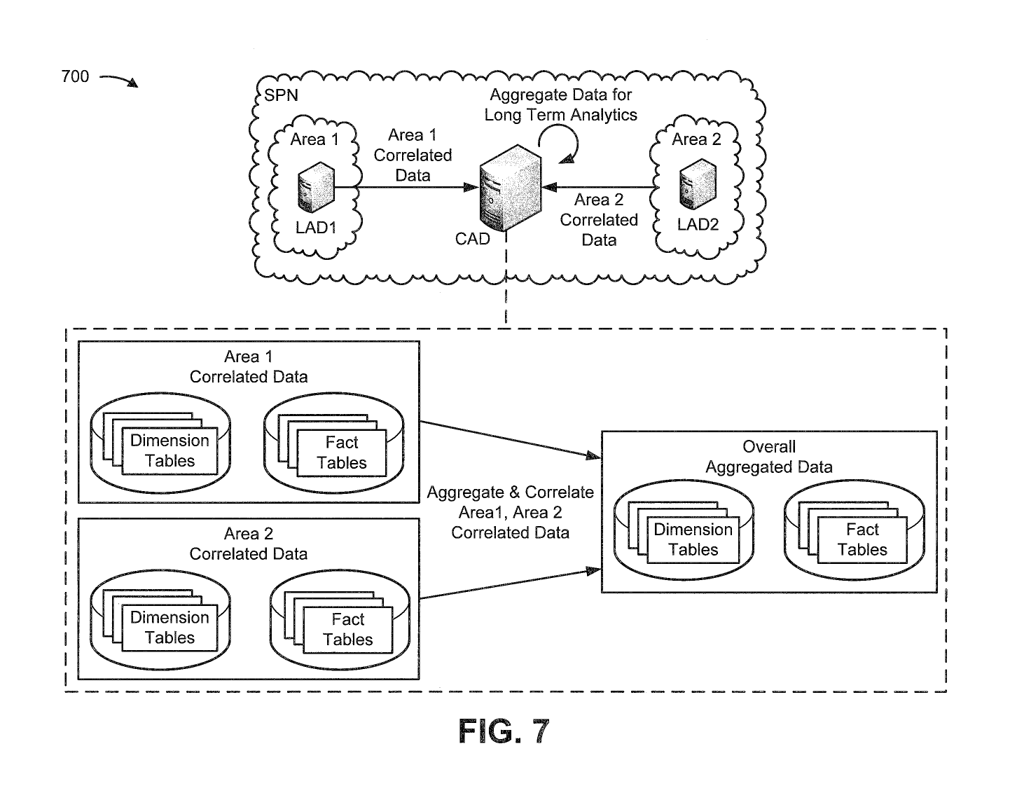

FIG. 7 is a diagram of an example implementation 700 relating to example process 600 shown in FIG. 6. For the purposes of example implementation 700, assume that a central analytics device, CAD, associated with a service provider network, SPN, is configured to receive correlated data from a first local analytics device, LAD1, included in an area 1 network and second local analytics device, LAD2, included in an area 2 network (e.g., when the area 1 network and the area 2 network are included in the SPN network).

As shown in FIG. 7, CAD may receive, from LAD1, fact tables and dimension tables that include area 1 correlated data. As further shown, CAD may also receive, from LAD2, fact tables and dimension tables that include area 2 correlated data. As shown, CAD may determine (e.g., based on receiving the correlated data) that CAD is to aggregate and correlate the correlated data received from LAD1 and LAD2. As further shown, CAD may correlate the aggregated data (e.g., by identifying a relationship between two or more pieces of correlated data), and may store the correlated aggregated data in a group of fact and dimension tables (e.g., such that the aggregated data is optimized to be read by CAD for the performance of long term analytics).

As indicated above, FIG. 7 is provided merely as an example. Other examples are possible and may differ from what was described with regard to FIG. 7.

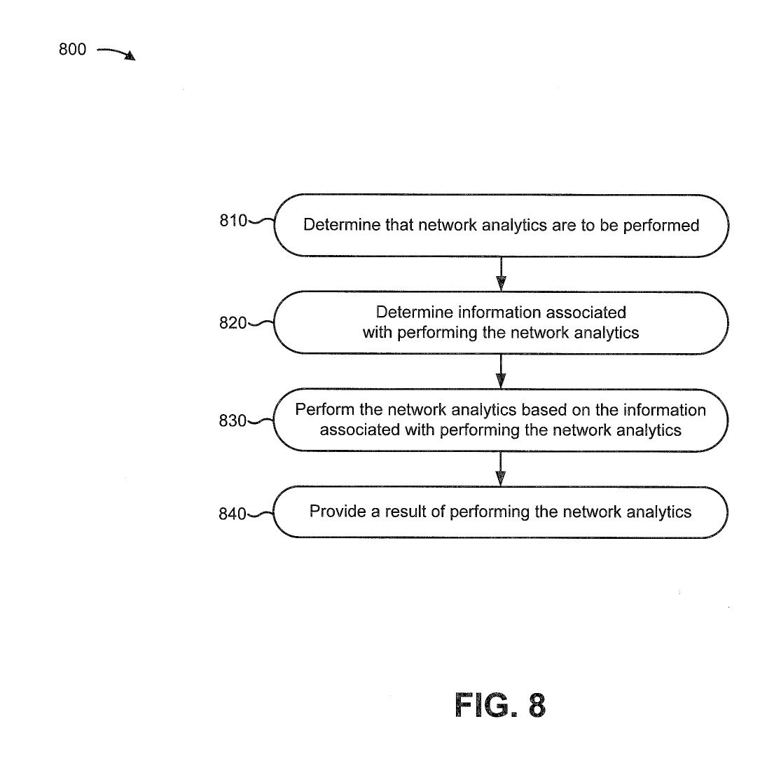

FIG. 8 is a flow chart of an example process 800 for performing network analytics and providing a result of the network analytics. In some implementations, one or more process blocks of FIG. 8 may be performed by central analytics device 250. In some implementations, one or more process blocks of FIG. 8 may be performed by another device or a group of devices separate from or including central analytics device 250, such as local analytics device 230.

As shown in FIG. 8, process 800 may include determining that network analytics are to be performed (block 810). For example, central analytics device 250 may determine that network analytics are to be performed. In some implementations, central analytics device 250 may determine that the network analytics are to be performed when central analytics device 250 aggregates correlated information to create aggregated information. Additionally, or alternatively, central analytics device 250 may determine that the network analytics are to be performed when central analytics device 250 stores the aggregated information. Additionally, or alternatively, central analytics device 250 may determine that the network analytics are to be performed when another device (e.g., local analytics device 230, another device included in network 260) provides information indicating that the network analytics are to be performed.

In some implementations, central analytics device 250 may determine that the network analytics are to be performed based on information stored by central analytics device 250. For example, central analytics device 250 may store information indicating that central analytics device 250 is to perform network analytics (e.g., associated with a particular forecast model) at a particular interval of time (e.g., every seven days), and central analytics device 250 may determine that central analytics device 250 is to perform the network analytics based on the stored information. Additionally, or alternatively, central analytics device 250 may determine that central analytics device 250 is to perform the network analytics based on information received from another device. For example, an administrator, associated with network 260, may provide, to central analytics device 250, information indicating that central analytics device 250 is to perform the network analytics, and central analytics device 250 may perform the network analytics based on the information received from the administrator device.

In some implementations, central analytics device 250 may determine a type of network analytics to be performed (e.g., short term analytics, long term analytics, etc.). Additionally, or alternatively, central analytics device 250 may determine a procedure associated with performing the network analytics. For example, central analytics device 250 may determine that central analytics device 250 is to perform network analytics using a deterministic algorithm (e.g., when analytics information is compared against a forecast model and/or a specification, and performance issues are detected based on comparing the analytics information to the forecast model and/or the specification, etc.). As an additional example, central analytics device 250 may determine that the central analytics device 250 is to perform network analytics using a non-deterministic algorithm (e.g., when central analytics device 250 detects patterns, associated with aggregated analytics information, based on derivatives, standard deviations, etc. associated with the aggregated analytics information).

As further shown in FIG. 8, process 800 may include determining information associated with performing the network analytics (block 820). For example, central analytics device 250 may determine information associated with performing the network analytics. In some implementations, central analytics device 250 may determine the information associated with performing the network analytics when central analytics device 250 determines that the network analytics are to be performed. Additionally, or alternatively, central analytics device 250 may determine the information associated with performing the network analytics when central analytics device 250 receives information, indicating that central analytics device 250 is to determine the information associated with performing the network analytics, from another device (e.g., a device included in network 260, local analytics device 230, etc.).

In some implementations, the information associated with performing the network analytics may include correlated information that is to be used when performing the network analytics (e.g., when central analytics device 250 is to perform short term network analytics). Additionally, or alternatively, the information associated with performing the network analytics may include aggregated information that is to be used when performing the network analytics (e.g., when central analytics device 250 is to perform long term network analytics). Additionally, or alternatively, the information associated with performing the network analytics may include information associated with performing deterministic analytics (e.g., information associated with a forecast model to be used when performing short term analytics, information associated with a forecast model to be used when performing long term analytics, etc.). Additionally, or alternatively, the information associated with performing the network analytics may include information associated with performing non-deterministic analytics (e.g., an algorithm associated with performing the non-deterministic analytics).

In some implementations, central analytics device 250 may determine the information associated with performing the network analytics based on information stored by central analytics device 250. For example, central analytics device 250 may determine that central analytics device 250 is to perform a particular type of network analytics (e.g., long term deterministic analytics associated with a QoS queue backlog forecast model), and central analytics device 250 may determine information associated with performing the network analytics (e.g., aggregated analytics information, information associated with a QoS queue backlog forecast model, etc.) based on information stored by central analytics device 250. Additionally, or alternatively, central analytics device 250 may determine the information associated with performing the network analytics based on information stored by another device (e.g., when another device stores information associated with the QoS queue backlog forecast model, and the other device provides the information to central analytics device 250, etc.).

In some implementations, the information associated with performing the network analytics may include information associated with a forecast model. A forecast model may include a statistical model that is designed to predict and/or estimate future behavior associated with area network 240 and/or network 260 (e.g., a future QoS queue backlog size, a future traffic arrival rate, a future quantity of traffic congestion, etc.).

For example, the forecast model may include an algorithm that may be used to predict QoS Class Identifier (“QCI”) level backlog size associated with a particular network element and/or particular QoS. The QCI level backlog size forecast model may predict the QCI level backlog size at a future time based on information associated with a previous QCI level backlog size (e.g., determined at an earlier time), information associated with the network, and queue information associated with the QCI level.

In some implementations, the QCI level backlog size forecast model may include a forecasting technique (e.g., an autoregressive integrated moving average model, a Kalman filter algorithm, etc.) that may predict the QCI backlog size based on a known (e.g., previously determined) QCI backlog size at a previous time. Additionally, or alternatively, the QCI level backlog size forecast model may include features associated with incoming traffic (e.g., an observed traffic arrival rate determined using another forecast model), information associated with a queue statistic (e.g., a quantity of dropped packets), information associated with a network interface status (e.g., a quantity of dropped packets, information associated with an interface utilization, etc.), information associated with a QoS engine (e.g., a queue capacity, a queue weight, a QCI, a policer committed information rate (“CIR”), a policer peak information rate (“PIR”), a policer committed burst size (“CBS”), a policer excess burst size (“EBS”), etc.), information associated with a network interface (e.g., an interface speed capacity, an interface type, a shaper CIR, a shaper, PIR, a shaper CBS, a shaper EBS, etc.), or the like. Additionally, or alternatively, the QCI level backlog size forecast model may include time based information (e.g., a time of the day, a day of the week, a week of the year, etc.). In some implementations, the QCI level backlog size forecast model may be modified to improve forecast accuracy (e.g., by selecting a subset of the above features to include in the model, by adding additional features to be included in the model, etc.).

In some implementations, the forecast model may be used to optimize area network 240 and/or network 260 (e.g., network devices 220 may be configured based on a prediction generated by the forecast model). In some implementations, central analytics device 250 may determine the forecast model (e.g., based on aggregated configuration data, based on aggregated specification data, etc.). Additionally, or alternatively, central analytics device 250 may receive information associated with the forecast model from another device (e.g., when the other device creates and stores information associated with the forecast model).

As further shown in FIG. 8, process 800 may include performing the network analytics based on the information associated with performing the network analytics (block 830). For example, central analytics device 250 may perform the network analytics based on the information associated with performing the network analytics. In some implementations, central analytics device 250 may perform the network analytics when central analytics device 250 determines the information associated with performing the network analytics (e.g., after central analytics device 250 determines the information associated with performing the network analytics). Additionally, or alternatively, central analytics device 250 may perform the network analytics when central analytics device 250 receives information, indicating that central analytics device 250 is to perform the network analytics, from another device (e.g., another device included in network 260).

In some implementations, central analytics device 250 may perform the network analytics based on the information associated with performing the network analytics. For example, central analytics device 250 may determine that central analytics device 250 is to perform long term deterministic analytics based on aggregated information and information associated with a forecast model, and central analytics device 250 may perform the long term deterministic analytics based on the aggregated information and the information associated with the forecast model (e.g., by comparing the correlated information to an output generated by the forecast model). As another example, central analytics device 250 may determine that central analytics device 250 is to perform long term non-deterministic analytics based on the aggregated information and a non-deterministic analytics algorithm, and central analytics device 250 may perform the long term non-deterministic analytics based on the aggregated information and the non-deterministic analytics algorithm (e.g., by using the non-deterministic analytics algorithm to identify patterns in the aggregated information).

In some implementations, central analytics device 250 may determine, based on performing the network analytics, a result that may indicate a manner in which area network 240 and/or network 260 may be optimized. For example, central analytics device 250 may determine a result associated with optimizing one or more network devices 220 (e.g., a result associated with reconfiguring network devices 220), included in network 260, based on performing the network analytics.

As further shown in FIG. 8, process 800 may include providing a result of performing the network analytics (block 840). For example, central analytics device 250 may provide a result of performing the network analytics. In some implementations, central analytics device 250 may provide the result when central analytics device 250 performs the network analytics (e.g., after central analytics device 250 performs the network analytics and determines the result). Additionally, or alternatively, central analytics device 250 may provide the result when central analytics device 250 receives information, indicating that central analytics device 250 is to provide the result, from another device (e.g., another device included in network 260, etc.).

In some implementations, central analytics device 250 may provide the result to a device (e.g., a self-optimizing network (“SON”) device, a software-defined network (“SDN”) controller, etc.) associated with optimizing area network 240 and/or network 260, and the other device may optimize area network 240 and/or network 260 (e.g., by reconfiguring network devices 220 included in area network 240 and/or network 260). In some implementations, central analytics device 250 may provide the result to another device (e.g., the SON device, the SDN device, etc.) and the other device may automatically optimize area network 240 and/or network 260 based on receiving the result. Additionally, or alternatively, central analytics device 250 may provide the result to the other device, and a network administrator (e.g., associated with optimizing area network 240 and/or network 260) may determine a manner in which to optimize area network 240 and/or network 260 based on the result.

Additionally, or alternatively, central analytics device 250 may provide the result such that a forecast model may be modified. For example, the result may indicate that the information associated with the forecast model is to be modified (e.g., to provide a better prediction), and central analytics device 250 may provide the result to a device that stores the information associated with forecast model (e.g., to allow the forecast model to be updated). In other words, the result may be provided to allow the forecast model to be improved, and the forecast model may be modified based on the result.

While the process blocks of FIG. 8 have been described as being performed by central analytics device 250, one or more of the process blocks of FIG. 8 may also be performed by local analytics device 230. For example, local analytics device 230 may determine that short term analytics are to be performed (e.g., after local analytics device 230 stores correlated information), may determine information (e.g., the correlated information stored by local analytics device 230, information associated with a forecast model, etc.) associated with performing the short term analytics, may perform the short term analytics, and may provide a result associated with performing the short term analytics (e.g., a result associated with optimizing the performance of area network 240).

Although FIG. 8 shows example blocks of process 800, in some implementations, process 800 may include additional blocks, different blocks, fewer blocks, or differently arranged blocks than those depicted in FIG. 8. Additionally, or alternatively, one or more of the blocks of process 800 may be performed in parallel.

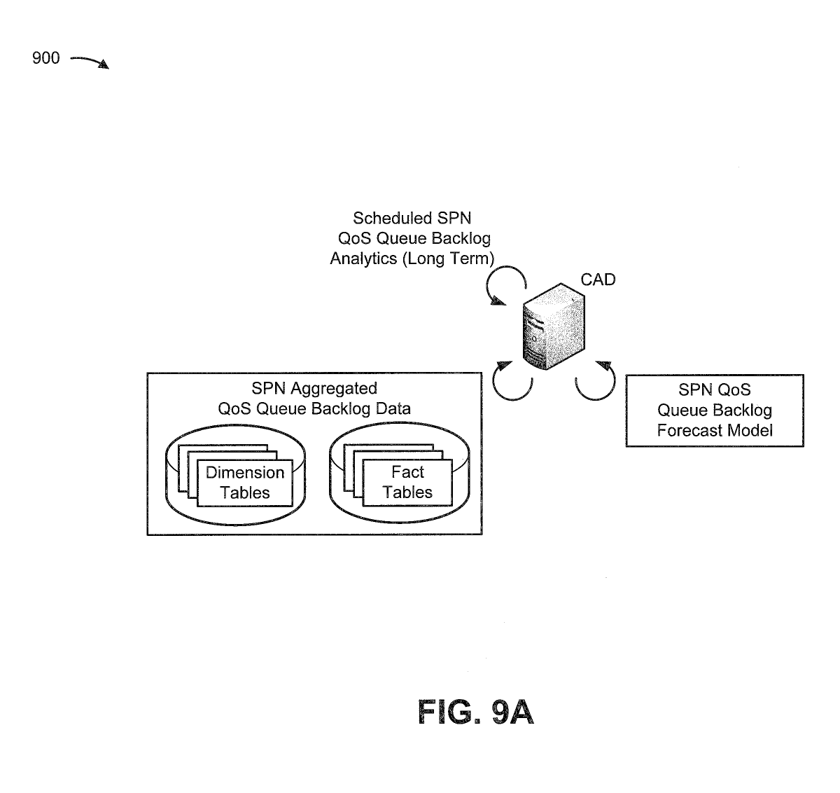

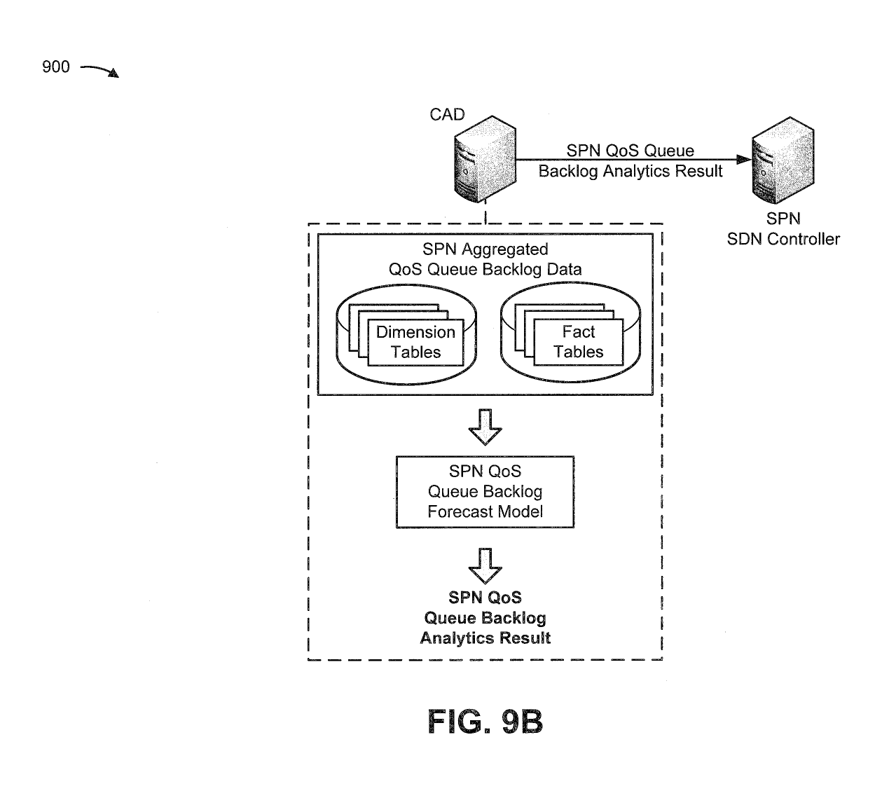

FIGS. 9A and 9B are diagrams of an example implementation 900 relating to example process 800 shown in FIG. 8. For the purposes of example implementation 900, assume that a central analytics device, CAD (e.g., associated with a network, SPN) has received (e.g., from two or more local analytics devices associated with the SPN network) correlated QoS queue backlog data associated with the SPN network. Further, assume that CAD has aggregated the correlated data, and stored the aggregated data in fact tables and dimension tables such that long term analytics may be performed in an optimized manner.

As shown in FIG. 9A, CAD may determine (e.g., based on information stored by CAD) that CAD is to perform SPN QoS queue backlog long term analytics. As further shown, CAD may determine information associated with performing the QoS queue backlog long term analytics by determining (e.g., based on information stored by CAD) SPN aggregated QoS queue backlog data and information associated with a SPN QoS queue backlog forecast model.

As shown in FIG. 9B, CAD may perform the SPN QoS queue backlog long term analytics by comparing the SPN aggregated QoS queue backlog data to the information associated with the SPN QoS queue backlog forecast model (e.g., such that CAD may determine whether a network device, associated with managing the SPN QoS queue backlog, may be optimized by reconfiguring the device and/or by updating the QoS queue backlog model used to configure the network device). As shown, CAD may determine a result (e.g., a result indicating that the SPN network device may be optimized by reconfiguring the network device), and CAD may provide the result to a device associated with optimizing the SPN network (e.g., an SPN SDN controller associated with optimizing area 1 network devices).

As indicated above, FIGS. 9A and 9B are provided merely as an example. Other examples are possible and may differ from what was described with regard to FIGS. 9A and 9B. For example, while FIGS. 9A and 9B describe long term deterministic analytics being performed by a central analytics device, the methods described with regard to FIGS. 9A and 9B may also be applied in another use case (e.g., when a local analytics device is to perform short term analytics using correlated information stored by the local analytics device, etc.).

Implementations described herein may allow a network analytics device to collect and process raw analytics information, associated with a network, such that a variety of network analytics (e.g., short term analytics, long term analytics, deterministic analytics, non-deterministic analytics, etc.) may be performed in an optimized manner.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

To the extent the aforementioned implementations collect, store, or employ personal information provided by individuals, it should be understood that such information shall be used in accordance with all applicable laws concerning protection of personal information. Storage and use of personal information may be in an appropriately secure manner reflective of the type of information, for example, through various encryption and anonymization techniques for particularly sensitive information.

It will be apparent that systems and/or methods, as described herein, may be implemented in many different forms of software, firmware, and hardware in the implementations shown in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A system, comprising:
one or more devices to:
receive raw information associated with a network,
the raw information including information associated with a group of network devices included in the network;
prepare the raw information to create optimized information,
the optimized information including the raw information that has been sorted based on a type of information associated with the raw information;
correlate the optimized information to create a set of correlated information,
the set of correlated information including information that identifies a relationship between at least two portions of the optimized information;
aggregate at least two sets of correlated information to create aggregated information,
the aggregated information including information that identifies a relationship between at least two portions of the at least two sets of correlated information;
determine that network analytics are to be performed using the set of correlated information or the aggregated information;
determine information associated with performing the network analytics,
the information including the set of correlated information or the aggregated information;
perform the network analytics based on the information associated with performing the network analytics; and
provide a result associated with performing the network analytics,
the result indicating a manner in which to improve a performance of a network device of the group of network devices.

2. The system of claim 1, where the one or more devices are further to:
determine that a portion of the raw information is missing from the raw information;
determine an extrapolated portion of information based on determining that the portion of the raw information is missing; and
where the one or more processors, when preparing the raw information, are further to:
prepare the raw information by adding the extrapolated portion of information to the raw information.

3. The system of claim 1, where the one or more devices, when preparing the raw information to create the optimized information, are further to:
create a group of dimension tables that includes the optimized information;
create a group of fact tables based on the group of dimension tables; and
store the group of dimension tables and the group of fact tables such that the group of dimension tables and the group of fact tables are available to create the set of correlated information.

4. The system of claim 1, where the one or more devices, when correlating the optimized information to create the set of correlated information, are further to:
create a group of dimension tables that includes the set of correlated information;
create a group of fact tables based on the group of dimension tables; and
store the group of dimension tables and the group of fact tables such that the group of dimension tables and the group of fact tables are available to perform short term analytics.

5. The system of claim 1, where the one or more devices are further to:
determine that short term analytics are to be performed; and
where the one or more processors, when determining that the network analytics are to be performed using the set of correlated information or the aggregated information, are further to:
determine that the networks analytics are to be performed using the set of correlated information based on determining that short term analytics are to be performed.

6. The system of claim 1, where the one or more devices, when determining the information associated with performing the network analytics, are further to:
determine information associated with a forecast model associated with performing the network analytics.

7. The system of claim 1, where the one or more devices, when providing the result associated with performing the network analytics, are further to:
provide the result to a device associated with optimizing a performance of the network.

8. A computer-readable medium storing instructions, the instructions comprising:
one or more instructions that, when executed by one or more processors, cause the one or more processors to:
receive raw data associated with a network,
the raw data including data associated with network devices included in the network;
process the raw data to create optimized data,
the optimized data including raw data that has been sorted based on a type of data associated with the raw data;
correlate the optimized data to create a set of correlated data,
the set of correlated data identifying a relationship between portions of the optimized data;
aggregate a plurality of sets of correlated data to create aggregated data,
the aggregated data identifying a relationship between at least two portions of the plurality of sets of correlated data;
determine that network analytics are to be performed using the set of correlated data or the aggregated data;
determine information associated with performing the network analytics,
the information including the set of correlated data or the aggregated data;
perform the network analytics based on the information associated with performing the network analytics; and
provide a result associated with performing the network analytics,
the result indicating a manner in which to improve a configuration of the network.

9. The computer-readable medium of claim 8, where the one or more instructions, when executed by the one or more processors, further cause the one or more processors to:
determine that a portion of the raw data is unavailable;
determine an extrapolated portion of data based on determining that the portion of the raw data is unavailable; and
where the one or more instructions, that cause the one or more processors to, process the raw data, further cause the one or more processors to:
process the raw data by adding the extrapolated portion of data to the raw data.

10. The computer-readable medium of claim 8, where the one or more instructions, that cause the one or more processors to correlate the optimized data to create the set of correlated data, further cause the one or more processors to:
create a group of dimension tables that includes the set of correlated data;
create a group of fact tables based on the group of dimension tables; and
store the group of dimension tables and the group of fact tables such that the group of dimension tables and the group of fact tables are available to perform short term analytics.

11. The computer-readable medium of claim 8, where the one or more instructions, that cause the one or more processors to aggregate the plurality of sets of correlated data to create aggregated data, further cause the one or more processors to:
create a group of dimension tables that includes the aggregated data;
create a group of fact tables based on the group of dimension tables; and
store the group of dimension tables and the group of fact tables such that the group of dimension tables and the group of fact tables are available to perform long term analytics.

12. The computer-readable medium of claim 8, where the one or more instructions, when executed by the one or more processors, further cause the one or more processors to:
determine that short term analytics are to be performed; and
where the one or more instructions, that cause the one or more processors to determine that the network analytics are to be performed using the set of correlated data or the aggregated data, further cause the one or more processors to:
determine that the networks analytics are to be performed using the set of correlated data based on determining that short term analytics are to be performed.

13. The computer-readable medium of claim 8, where the one or more instructions, when executed by the one or more processors, further cause the one or more processors to:
determine that long term analytics are to be performed; and
where the one or more instructions, that cause the one or more processors to determine that the network analytics are to be performed using the set of correlated data or the aggregated data, further cause the one or more processors to:
determine that the networks analytics are to be performed using the aggregated data based on determining that long term analytics are to be performed.

14. The computer-readable medium of claim 8, where the one or more instructions, that cause the one or more processors to determine the information associated with performing the network analytics, further cause the one or more processors to:
determine information associated with performing deterministic network analytics.

15. A method, comprising:
receiving, by one or more devices, raw information associated with performing network analytics;
processing, by the one or more devices, the raw information to generate optimized information,
the raw information being processed based on a type of information associated with the raw information;
correlating, by the one or more devices, the optimized information to generate a set of correlated information,
the set of correlated information including information indicating a relationship between portions of the optimized information;
aggregating, by the one or more devices, sets of correlated information to generate aggregated information,
the sets of correlated information including the set of correlated information, and
the aggregated information including information indicating a relationship between portions of the sets of correlated information;
determining, by the one or more devices, that network analytics are to be performed using the set of correlated information or the aggregated information;
identifying, by the one or more devices, information associated with performing the network analytics,
the information including the set of correlated information or the aggregated information and including a model associated with computing the network analytics;
computing, by the one or more devices, the network analytics based on the information associated with computing the network analytics; and
providing, by the one or more devices, a result based on computing the network analytics,
the result indicating a manner in which to improve a performance of a network device included in the network.

16. The method of claim 15, further comprising:
determining that a portion of the raw information is missing; and
providing an indication, associated with the missing raw information,
the indication indicating that additional information is to be collected in the future such that there is no missing raw information.

17. The method of claim 15, where aggregating the sets of correlated information to generate aggregated information further comprises:
generating a group of dimension tables that includes the aggregated information;
generating a group of fact tables based on the group of dimension tables; and
storing the group of dimension tables and the group of fact tables such that the group of dimension tables and the group of fact tables are available to perform long term analytics.

18. The method of claim 15, further comprising:
determining that long term analytics are to be performed; and
where determining that the network analytics are to be performed using the set of correlated information or the aggregated information further comprises:
determining that the networks analytics are to be performed using the aggregated information based on determining that long term analytics are to be performed.

19. The method of claim 15, where identifying the information associated with performing the network analytics further comprises:
identifying information associated with performing non-deterministic network analytics.

20. The method of claim 15, further comprising:
generating the model based on the raw information, the optimized information, the correlated information, or the aggregated information; and
where computing the network analytics further comprises:
computing the network analytics based on the model.
